(19) United States
(12) Patent Application Publication
(10) Pub. No.: US 2008/0309762 A1
(43) Pub. Date: Dec. 18, 2008

(54) In-vehicle mobile digital video surveillance recorder system with GPS visual mapping and navigation

(76) Inventors: Richie Howard, Dothan, AL (US); Thomas C. Howard, Palquemine, LA (US)

Correspondence Address: JACOBSON HOLMAN PLLC, 400 SEVENTH STREET N.W., SUITE 600, WASHINGTON, DC, 20004, US

(21) Appl. No.: 12/081,395

(22) Filed: Apr. 15, 2008

Related U.S. Application Data
(60) Provisional application No. 60/929,075, filed on Jun. 12, 2007.

(51) Int. Cl. H04N 7/18

(52) U.S. Cl. 348/148; 348/E07.085

(57) ABSTRACT

A mobile digital video surveillance recorder with GPS mapping capability is provided that is carried by a vehicle and equipped with a plurality of channel inputs. An associated monitor can be carried by the vehicle to allow the driver to view the camera images being recorded real-time, or the monitor can be located remotely for playback and review of the recorded images at a later time. The monitor displays a split screen that can display one or more images as taken from different cameras. Video feed from an associated GPS navigation system is piped into one of the video channel inputs such that GPS location with mapping is visually displayed as one of the remaining split-screen images on the monitor. The displayed data therefore presents concurrent images of camera video and GPS video feed so that the specific location of the vehicle at the time a camera image was recorded is presented.

This application is entitled to and hereby claims the priority of co-pending U.S. Provisional application, Ser. No. 60/929,075 filed Jun. 12, 2007.

### BACKGROUND OF THE INVENTION

1. Field of the Invention

The present invention is related to the field of video surveillance and, more particularly, to a system for combining images recorded by a digital video recorder on a vehicle with GPS mapping data correlated to and simultaneously with the time the images were recorded.

2. Description of the Related Art

Video recorders are installed on various transportation vehicles which record images of the passengers and/or other views relating to the vehicle and its occupants. These same vehicles are often equipped with GPS navigation systems that allow the locations of the vehicles to be tracked. In the event of an accident or other incident involving the vehicle or the actions of its occupants, however, there is currently no means for correlating the occurrence of events within or outside the vehicle with the specific location of the vehicle at the time of the events.

### SUMMARY OF THE INVENTION

In view of the foregoing, one object of the present invention is to overcome the difficulties of correlating the specific location of a motorized vehicle at the time of an incident occurring within or outside the vehicle.

Another object of the present invention is to provide a video surveillance system for use on a motorized vehicle that records exact location of the vehicle as it relates to video visual files of events occurring within or outside the vehicle.

A further object of the present invention is to provide a video recording system for use on a motorized vehicle that stores visual images simultaneously with vehicle location information for later review whenever desired.

Yet another object of the present invention is to provide a method of connecting a digital video surveillance recording system so as to display both visual images from one or more cameras and synchronized GPS vehicle location information.

A still further object of the present invention is to provide a video surveillance system with synchronized vehicle location tracking that is not complex in configuration and which can be installed easily and at low cost but yet efficiently provides valuable occurrence and location tracking information.

In accordance with these and other objects, the present invention is directed to a mobile digital video surveillance recorder equipped with a plurality of channel inputs and having an associated monitor that allows the driver or other individual remote from the vehicle to visually monitor the images being recorded. The monitor displays a split screen that includes two or more images as taken from different cameras. Video feed from an associated GPS navigation system is connected into one of the video channel inputs such that GPS location with mapping is visually displayed as one of the split-screen images on the monitor. The displayed data, including concurrent images of camera video and GPS video feed, is also recorded for subsequent review.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a mobile digital video surveillance recorder (MDVSR) system with integrated GPS navigation data in accordance with the present invention.

FIG. 2 is a block diagram of a hard drive removed from a vehicle's MDVSR and plugged into a personal computer for subsequent review on the computer's monitor in accordance with the present invention.

FIG. 3 is a representative view of recorded output from the MDVSR system with integrated GPS navigation data using the split screen of FIG. 2, as presented during playback.

FIG. 4 is a block diagram of some of the inputs and outputs with which the MDVSR system can be configured in accordance with the present invention.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

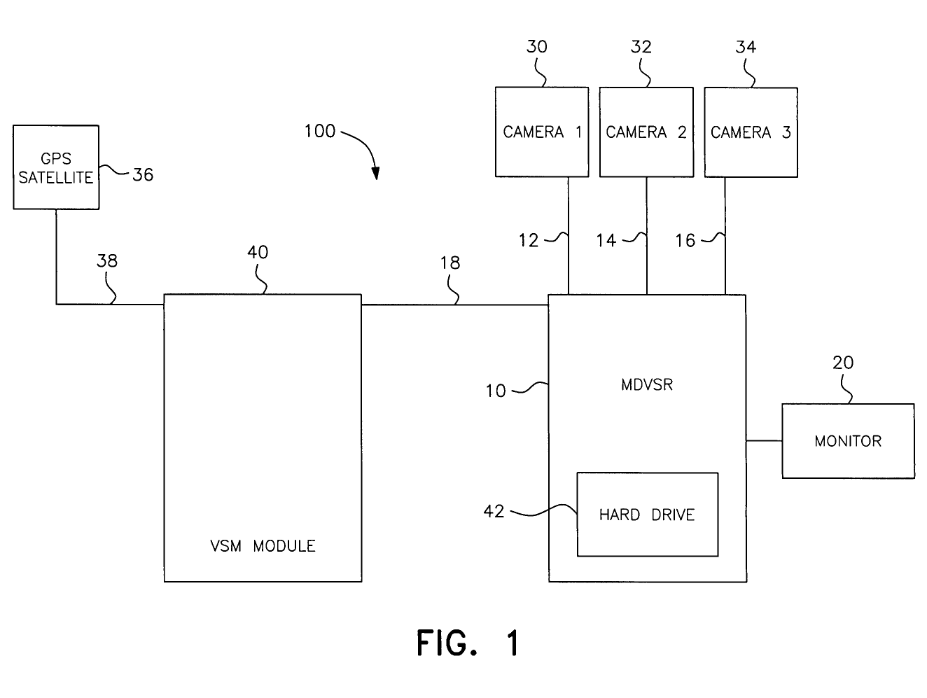

As shown in FIG. 1, the present invention is directed to a mobile digital video surveillance recorder (MDVSR) system generally designated by the reference numeral 100. The MDVSR system 100 includes a mobile digital video surveillance recorder 10 equipped with a plurality of channel inputs, here embodied as four channel inputs 12, 14, 16, 18. Video signals from a plurality of cameras 30, 32, 34 are input to three of the channel inputs 12, 14, 16, respectively. The fourth channel input 18, however, receives an output from a GPS navigation module 40; alternatively, the GPS module 40 may be integrated with the MDVSR 10 (see FIG. 4). The GPS navigation module 40 is in communication with a GPS satellite 36 as is known in the art.

Just as any of the camera inputs can be connected to any of the respective cameras, any of the plurality of channel inputs can be connected to the GPS navigation module 40. Alternatively, the GPS navigation module 40 can be built into the MDVSR system so that an external GPS device is not required.

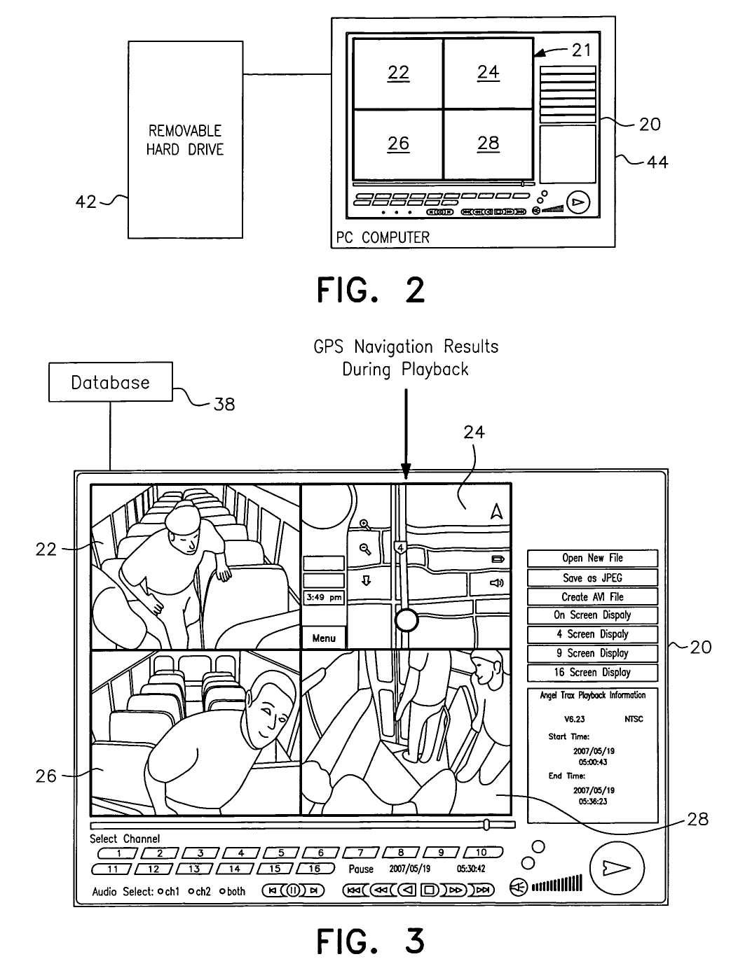

A monitor 20 can be connected to the MDVSR and located in the vehicle to provide a display of live video and navigation information to the driver on a real-time basis as is represented by FIG. 1. More commonly, however, the monitor 20 is located remotely for review of the recorded images during playback mode by another individual. In this latter case, camera and GPS map data video are recorded by the MDVSR and saved to a hard drive 42 which is preferably removable from the MDVSR. When removable, the hard drive 42 is thereafter taken from the MDVSR and connected to a remotely located computer 44 for review of the recorded data at a later time (see FIG. 2). Alternatively, the recorded files stored on a permanent hard drive or other memory device within the MDVSR can be downloaded to another device if the memory device is not removable.

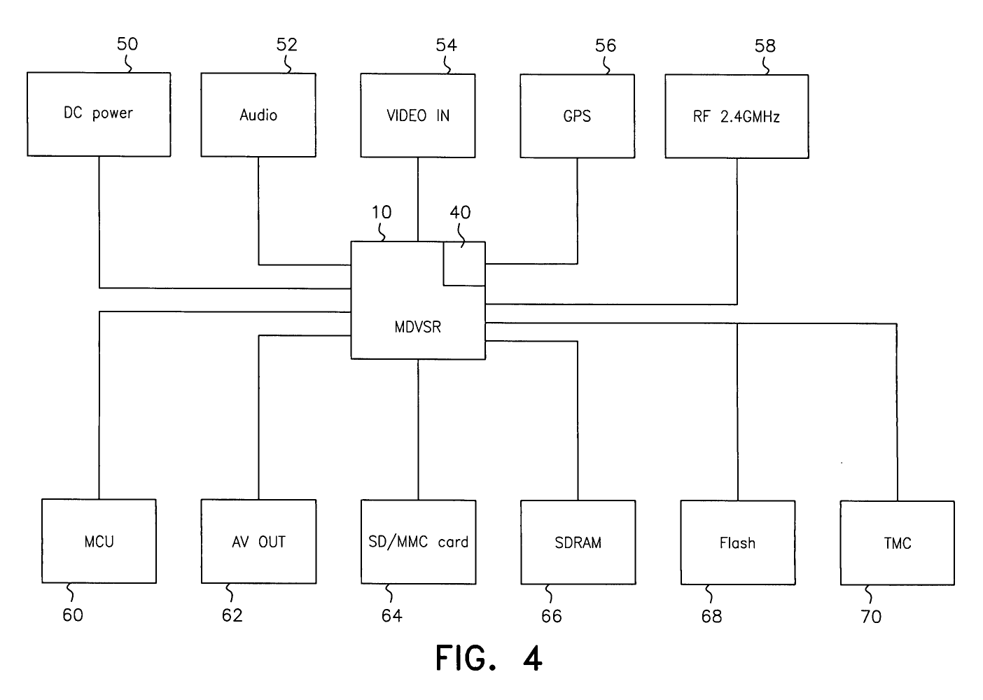

As shown in FIGS. 2 and 3, the monitor 20 displays a split screen 21 which, according to a preferred embodiment, includes four views 22, 24, 26, 28. In this embodiment, the result of the four channel inputs is as shown on the monitor 20. The upper left view 22, lower left view 26 and lower right view 28 on the split screen show monitored areas of the vehicle interior and persons riding in the vehicle. The upper right view 24 contains the GPS navigation images. While in this embodiment the split screen has four views corresponding with four channel inputs, digital video surveillance recorders in accordance with the present invention may be equipped with numerous channel inputs well in excess of four, and can also be provided to supply a corresponding number of views on the split screen monitor, one of which is devoted to GPS navigation images.

According to a preferred embodiment, the MDVSR system 100 records the video and navigation data to the removable hard drive 42 or other memory device for connection to a computer or other viewing device 44 for subsequent playback and review. In reviewing the images, the recorded GPS map data and camera video input from all the video channels 12, 14, 16 and 18 are synchronized via the time and date of the GPS navigation mapping data so that the events occurring on the vehicle and recorded by the recorder can be immediately correlated with the location of the vehicle when the events occurred.

The information available with the present invention provides administrators, transportation directors and Homeland Security personnel with a valuable tool that can provide important information concerning exact location as it pertains to video visual files. By visually displaying the video feed concurrently with data from an associated GPS navigation system, the task of safety personnel in reconstructing and reviewing events on the vehicle as related to vehicle location is greatly simplified.

As shown in FIG. 2, the displayed data, including concurrent images of camera video and GPS video feed, is recorded to the removable hard drive 42 for subsequent review. The user has the option to download the files or remove the hard drive for playback review. As can be seen, when reviewing any incident recorded by the cameras, the user can simultaneously determine the exact location of the vehicle when the incident occurred.

Since the visual and GPS data is recorded directly on the mobile digital video surveillance recorder system, the user can choose any time or date and review the associated location results during any incident.

The MDVSR system 100 according to the present invention can be utilized effectively in a wired or wireless configuration. If the vehicle is within the wireless canopy or wireless area network (WAN), the user can actually call up the mobile digital video surveillance recorder 10 from his or her office computer and, from there, view live video as well as live GPS position.

The MDVSR system 100 utilizes conventional digital video recorder equipment and connections as would be known by persons of ordinary skill in the art. As representatively shown in FIG. 4, the MDVSR 10 has a DC power input 50, as well as general input capability for audio 52, video 54, and GPS 56 as has already been discussed. The system is configured to receive data over an RF antenna 58 at 2.4 GMHz, although lesser input rates could also be accommodated.

The MDVSR is preferably controlled by a resident microcontroller 60, and includes one or more outputs for audiovisual information 62. Memory units used to store the recorded images and navigation data can include secure digital multi-media cards (SD/MMC) 64, synchronous dynamic random access memory (SDRAM) cards 66 or flash memory cards and devices 68 such as thumb drives, memory sticks, etc. Memory devices such as these are small and can be easily transported from the vehicle to a remotely located computer for review and storage as needed.

The MDVSR 10 can also be integrated with the traffic message channel (TMC) 70 to receive digitally coded traffic messages using the FM and/or radio broadcast data system (RBDS) on conventional FM radio broadcasts. Traffic messages on the TMC can also be transmitted on satellite radio and can be integrated into the vehicle's navigation system as is known in the art.

The present invention is also directed to a method of interconnecting a mobile digital video surveillance recorder having a plurality of channel inputs and an associated monitor with a GPS navigation system. One of the channel inputs is connected to the GPS navigation system while the other channel inputs are connected to a respective plurality of cameras positioned to record occurrences on a mobile vehicle. When the mobile digital video surveillance recorder is connected in accordance with the method, the monitor displays a split screen with a plurality of views, one of which corresponds with the output from the GPS navigation system. The other views on the monitor display images recorded by the plurality of cameras respectively connected to some or all of the remaining channel inputs.

The foregoing description and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A mobile digital video surveillance recorder system for a vehicle comprising:
a mobile digital video surveillance recorder (MDVSR) carried by the vehicle, said MDVSR having a plurality of channel inputs and a memory;
at least one camera carried by said vehicle and connected to one of said plurality of channel inputs and providing video images taken by said camera to said MDVSR for recording on said memory;
a GPS navigation module carried by said vehicle and connected to another of said plurality of channel inputs and providing video navigation images to said MDVSR for recording on said memory;
said MDVSR including a synchronizing component for time-synchronizing the recording of said camera images and said navigation images using time and date information from said GPS module so that each camera image can be mapped to a vehicle location when the image was taken; and
a viewing device capable of visually displaying said synchronized camera and navigation images concurrently.

2. The MDVSR system as set forth in claim 1, wherein said MDVSR, said at least one camera, and said GPS navigation module are installed on a passenger vehicle and are configured such that said camera takes pictures of a portion of the vehicle interior or exterior as the vehicle is stationary or moving, and said memory records the pictures and GPS navigation data recorded when the pictures were taken.

3. The MDVSR system as set forth in claim 1, wherein said vehicle is a commercial passenger bus.

4. The MDVSR system as set forth in claim 1, wherein said vehicle is a commercial taxi cab.

5. The MDVSR system as set forth in claim 2, wherein said memory is a removable memory device.

6. The MDVSR system as set forth in claim 5, wherein said viewing device is a computer having a monitor that is remotely located from said vehicle, said computer being configured to receive inputs from said removable memory device in order to display the camera and navigation images recorded thereon.

7. The MDVSR system as set forth in claim 6, wherein said monitor displays the camera and navigation images simultaneously on a split screen.

8. The MDVSR system as set forth in claim 2, further comprising a plurality of cameras, each connected to a respective one of said plurality of channel inputs to provide a plurality of camera images to said memory for recording simultaneously, all of said recorded camera images being synchronized to said navigation images so that each camera image is correlated with the location of the vehicle when the image was taken.

9. The MDVSR system as set forth in claim 8, wherein said monitor is mounted in the vehicle to enable the driver to view the images being recorded real-time.

10. The MDVSR system as set forth in claim 8, wherein said memory is a removable memory device.

11. The MDVSR system as set forth in claim 10, wherein said viewing device is a computer having a monitor that is remotely located from said vehicle, said computer being configured to receive inputs from said removable memory device in order to display the camera and navigation images recorded thereon.

12. The MDVSR system as set forth in claim 11, wherein said monitor displays the multiple camera and navigation images simultaneously on a split screen of said monitor.

13. A mobile digital video surveillance recorder system as installed on a moving vehicle moving from one location to another comprising:
a mobile digital video surveillance recorder (MDVSR) carried by the moving vehicle and having at least four channel inputs and a memory;
at least one camera carried by said vehicle and connected to one of said channel inputs and providing video images taken by said camera to said MDVSR for recording on said memory;
a GPS navigation module carried by said vehicle and connected to another of said four channel inputs and providing navigation images to said MDVSR for recording on said memory; and
said MDVSR including a synchronizing component for time-synchronizing the recording of video images taken by one or more cameras and said navigation images using time and date information from said GPS module so that each camera image is mapped to the vehicle location when the image was taken and can be viewed in conjunction with said location during playback of said stored video and navigation images.

14. The system as set forth in claim 13, further comprising a viewing device having a monitor remotely located from said vehicle, said monitor capable of visually displaying said synchronized camera and navigation images concurrently on a split screen that includes the navigation images in one portion of the screen and one or more camera images in one or more additional portions of the screen, the navigation images on said one portion providing the location of the vehicle when the camera images shown in the remaining screen portions were taken.

15. The system as set forth in claim 14, wherein said memory is a removable memory device and said viewing device includes a computer configured to receive data from said removable memory device.

16. The system as set forth in claim 14, wherein three cameras are connected to three of said four channel inputs and said GPS module is connected to a fourth channel input, said monitor split screen including four portions, three of said portions displaying camera images from said three cameras and the fourth portion displaying said navigation data indicating the location of the vehicle when the three camera images were taken.

17. A method of interconnecting a mobile digital video surveillance recorder having a plurality of channel inputs and an associated monitor with a GPS navigation system on a moving vehicle comprising:
connecting one of the channel inputs to the GPS navigation system to record GPS navigation data;
connecting one or more of the other channel inputs to a respective number of cameras positioned in the vehicle to record occurrences on the vehicle;
recording said GPS navigation data and said camera images and storing said data and images on a synchronized basis on a memory associated with said mobile digital video surveillance recorder so that each camera image can be mapped to a vehicle location when the image was taken; and
viewing the synchronized images on said monitor which displays a split screen with a plurality of views, one of said views corresponding with the output from the GPS navigation system and the other view or views on the monitor displaying images recorded by the camera or cameras, respectively.

18. The method as set forth in claim 17, wherein said step of viewing is performed on the vehicle real-time.

19. The method as set forth in claim 17, wherein said memory is removable and said monitor is located remotely from said vehicle, said step of viewing being performed at said monitor location at a later time.
